(19) United States
(12) Patent Application Publication
(10) Pub. No.: US 2024/0081336 A1
(43) Pub. Date: Mar. 14, 2024

(54) COLOR STABILIZATION OF BIOCIDAL COATINGS

(71) Applicant: Corning Incorporated, Corning, NY (US)

(72) Inventors: Bavani Balakrisnan, Corning, NY (US); Stephen Joseph Caracci, Elmira, NY (US); David Michael Fasano, Lansdale, PA (US); Joydeep Lahiri, Corning, NY (US); Joseph Martin Rokowski, Barto, PA (US)

(21) Appl. No.: 17/642,087

(22) PCT Filed: Sep. 9, 2020
(86) PCT No.: PCT/US2020/050790

§ 371 Date: Mar. 10, 2022

Related U.S. Application Data
(60) Provisional application No. 62/900,873, filed on Sep. 16, 2019.

(51) Int. Cl. A01N 59/20; A01N 25/12; A01P 1/00

(52) U.S. Cl. CPC A01N 59/20; A01N 25/12; A01P 1/00

(57) ABSTRACT

A biocidal material and method of forming is provided. The biocidal material includes a carrier and a plurality of treated copper-containing particles including a particle surface pre-treatment. The surface pre-treatment includes a copper-chelating material.

### CROSS-REFERENCE TO RELATED APPLICATION

This application claims the benefit of priority under 35 U.S.C. § 119 of U.S. Provisional Application No. 62/900,873 filed Sep. 16, 2019, the content of which is incorporated herein by reference in its entirety.

### FIELD

The present disclosure relates generally to materials having biocidal properties and methods of forming said materials, and more particularly to biocidal materials containing copper and methods of forming.

### BACKGROUND

Coatings or compositions such as paint can be applied on a substrate or surface or stored in a container. Over time, the coating or composition can be exposed to a number of undesired contaminants such as bacteria, viruses, mildew, mold, fungi, algae and the like. Exposure to these contaminants can render the coating or composition visually unattractive or unsuitable for a particular purpose or present a health hazard. It can therefore be desirable to mitigate the ability of the undesired contaminants to thrive once in contact with a coating or composition.

The antimicrobial properties of a number of inorganic materials, especially metals such as silver, copper, zinc, mercury, tin, gold, lead, bismuth, cadmium, chromium and thallium, have long been known. Of these metals, silver, zinc, gold and copper have been more commonly utilized for their antimicrobial properties due to their relatively low environmental and toxicological effects and high antimicrobial activity. Such metals have been incorporated into coatings or compositions such as paint as antimicrobial agents but have found limited commercial utility due in large part to their tendency to cause discoloration of the coating composition into which they are incorporated. Color stability of coating products can be extremely important where the products are intended to be used to coat readily visible surfaces, or where the coating product is intended to serve an aesthetic purpose.

In coating compositions, discoloration often occurs rapidly and can be detected within a short time period following the incorporation of an antimicrobial agent into the coating composition. Whether discoloration occurs rapidly or not, discoloration also manifests itself over time as a result of the occurrence of the interaction between the metal component and other reactive components in the coating composition and/or as a result of various environmental conditions such as humidity conditions, the presence of UV light, etc. . . .

Thus, there is a need for materials having biocidal properties that exhibit improved color stability and methods of forming such materials.

### SUMMARY

According to an embodiment of the present disclosure, a biocidal material includes a carrier and a plurality of treated copper-containing particles comprising a particle surface pre-treatment. The surface pre-treatment comprises a copper-chelating material.

According to an embodiment of the present disclosure, a method of forming biocidal material is provided. The method includes treating copper-containing particles with a copper-chelating material to form treated copper-containing particles and combining a carrier and the treated copper-containing particles.

According to an embodiment of the present disclosure, a material is provided. The material includes a carrier and copper-containing particles treated with at least one of an ammonia-based or amine-based solution, wherein the material exhibits a greater than 3 log reduction in a concentration of Staphylococcus aureus, under the EPA Test Method for Efficacy of Copper Alloy as a Sanitizer testing conditions.

According to another embodiment of the present disclosure, a method of forming a material is provided. The method includes treating copper-containing particles with at least one of an ammonia-based or amine-based solution to form treated copper-containing particles and combining a carrier and the treated copper-containing particles. The material exhibits a greater than 3 log reduction in a concentration of Staphylococcus aureus, under the EPA Test Method for Efficacy of Copper Alloy as a Sanitizer testing conditions.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a plot illustrating the change in color over time during in-can storage of paint samples containing treated copper-containing glass particles that have been pretreated with a pretreatment solution for 2, 5, 20.5, 24, 48, and 72 hours, according to embodiments of the present disclosure.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

As used herein, “have,” “having,” “include,” “including,” “comprise,” “comprising” or the like are used in their open ended sense, and generally mean “including, but not limited to.”

All scientific and technical terms used herein have meanings commonly used in the art unless otherwise specified. The definitions provided herein are to facilitate understanding of certain terms used frequently herein and are not meant to limit the scope of the present disclosure.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

According to embodiments of the present disclosure, a composition is described that can be effective for forming a biocidal material. According to embodiments of the present disclosure, the biocidal material includes a carrier and copper-containing particles that have been pre-treated with a copper-chelating material prior to combining with the carrier. The copper-containing particles can be in the form of copper (I) oxide (also referred to as cuprous oxide), copper (I) halides, copper (I) carbonate, and/or copper-containing glass. In some embodiments, the biocidal material can include an inorganic glass comprising a copper component that is pre-treated with an ammonia-based or amine-based solution. In some embodiments, the biocidal material can include a group (I) hydroxide, a group (II) hydroxide, and/or an alkaline buffer. The biocidal material can ultimately be a paint, a coating, an elastomeric coating, a caulk, a sealant, a floor polish, a fabric treatment, a stain, a clear coat, or a primer. Copper-containing particles as described herein can be combined with carriers while stabilizing the color of the carrier when the copper-containing particles are combined with the carrier. Embodiments of the present disclosure may reduce changes in the color of the carrier at the time of combining the copper-containing particles with the carrier and/or also reduce changes in the color of the carrier for a period of time after combining the copper-containing particles with the carrier.

The effectiveness of the composition as a biocidal material can be measured as a function of the composition's log reduction. The composition's log reduction value can be relevant to its ability to kill a wide variety of biological organisms to which it is exposed, but can also allow the copper-containing particles to act as a preservative for the composition during storage (e.g., in a container such as, but not limited to a tank, can, bucket, drum, bottle, or tube).

As used herein the term “antimicrobial,” means a material, or a surface of a material that will kill or inhibit the growth of microbes including bacteria, viruses, mildew, mold, algae, and/or fungi. The term as used herein does not mean the material or the surface of the material will kill or inhibit the growth of all species of microbes within such families, but that it will kill or inhibit the growth of one or more species of microbes from such families.

According to embodiments of the present disclosure, a log reduction of the biocidal material can be at least about 2, at least about 3, at least about 4, at least about 5, at least about 6, at least about 7, at least about 8, at least about 9, at least about 10, in a range of from about 1 to about 10, about 3 to about 7, about 4 to about 6, or less than, equal to, or greater than about 1, 2, 3, 4, 5, 6, 7, 8, 9, or about 10. As used herein the term “log reduction” means the negative value of log(Cₐ/C₀), where Cₐ=the colony form unit (CFU) number of the antimicrobial surface and C₀=the colony form unit (CFU) of the control surface that is not an antimicrobial surface. As an example, a 3 log reduction equals about 99.9% of the microbes killed and a log reduction of 5 equals about 99.999% of microbes killed. The log reduction value can be measured according to the ASTM D2574-16 (2016) “Standard Test Method for Resistance of Emulsion paints in the Container to Attack by Microorganisms.” The biocidal properties of the composition can make it effective for substantially killing a wide variety of biological organisms including bacteria, viruses, and fungi. Where the coating is configured to have biocidal properties with respect to bacteria, suitable examples of bacteria include Staphylococcus aureus, Enterobacter aerogenes, Pseudomomas aeruginosa, Methicillin Resistant Staphylococcus aureus, E. coli, and mixtures thereof.

In some embodiments, the material may exhibit the log reductions described herein under one or more of the U.S. Environmental Protection Agency “Test Method for Efficacy of Copper Alloy as a Sanitizer” (2009) (also referred to herein as the “EPA Test”), the Modified Japanese Industrial Standard (JIS) Z 2801 Test for Bacteria and/or the Modified JIS Z 2801 Test for Viruses (as described in more detail below), for a period of one month or greater or for a period of three months or greater. The one-month period or three-month period may commence at or after the application of the material to a surface as a layer. In such embodiments, the layer exhibits the log reductions described herein.

In some embodiments, the copper-containing particles can be in the form of an inorganic glass comprising a copper component in any suitable amount. For example, the copper can be present in a range of from about 5 wt % to about 80 wt % of the individual inorganic glass comprising a copper component, about 10 wt % to about 70 wt %, about 25 wt % to about 35 wt %, about 40 wt % to about 60 wt %, about 45 wt % to about 55 wt %, less than, equal to, or greater than about 5 wt %, 10, 15, 20, 25, 30, 35, 40, 45, 50, 55, 60, 65, 70, 75, or about 80 wt %. In each inorganic glass comprising a copper component, the copper portion can independently include a Cu metal, Cu⁺, Cu²⁺, or a combination of Cu⁺ and Cu²⁺. The copper can be non-complexed or can have a ligand bonded thereto to form a complex.

Although the copper-containing particles are effective as a biocidal agent, a potential drawback is that the copper offers numerous opportunities for ligands to attach thereto, resulting in complexes that can alter the color of the resulting composition. However, as described herein, it is possible to pre-treat the copper-containing particles with a copper-chelating material, examples of which include an ammonia-based and/or amine-based solution, in order to limit the extent to which the copper component is complexed and therefore limit the shift of the color of the biocidal material from the color of a standard coating material (e.g., the material in the absence of the copper-containing particles). For example it is possible to achieve a CIE L*a*b*ΔE* between the observed color and a standard of less than about 30, less than about 25, less than about 20, less than about 15, less than about 12, less than about 10, less than about 9, less than about 8, less than about 7, less than about 6, less than about 5, less than about 4, less than about 3, less than about 2, less than about 1, in a range of from about 1 to about 30, about 2 to about 25, about 5 to about 15, about 3 to about 8, about 4 to about 7, about 5 to about 6, less than, equal to, or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29 or about 30.

As understood, the CIE L*a*b* color space is a color scale for determining a color. The three coordinates (or dimensions/components) of CIE L*a*b* represent the lightness of the color (L*=0 indicates black and L*=100 indicates white), its position between red (sometimes referenced as magenta) and green (negative a* values indicate green while positive a* values indicate red) and its position between yellow and blue (negative b* values indicate blue and positive b* values indicate yellow). The L* component closely matches human perception of lightness. Related to the CIE L*a*b* color space, is the CIE L*C*h color space which is a cylindrical representation of the three perceptual color correlates: lightness, chroma, and hue. The axial component of CIE L*C*h is the same lightless attribute L* as CIE L*a*b*, the radial component is the chroma, and the angular component is hue. Using these color spaces, the difference (e.g., a ΔE*) in color between a standard and observed color can be measured. In this manner, the extent to which the desired color of a coating is altered by the components therein can be measured.

The copper-containing particles may include copper-containing glass, copper (I) oxide, copper (I) halides, copper (I) carbonate, or a combination thereof In some instances, the copper-containing particles may include only one of copper-containing glass, copper (I) oxide, copper (I) halides, copper (I) carbonate.

The copper-containing glass of the present disclosure can include an inorganic glass comprising a copper component that may include a Cu species. According to embodiments of the present disclosure, the Cu species may include Cu¹⁺, Cu⁰, and/or Cu²⁺. The combined total of the Cu species may be about 10 wt % or more of the glass. However, as will be discussed in more detail below, the amount of Cu²⁺ may be minimized or reduced such that the inorganic glass comprising a copper component is substantially free of Cu²⁺. The Cu¹⁺ ions may be present on or in the surface and/or the bulk of the inorganic glass comprising a copper component. In some embodiments, the Cu¹⁺ ions are present in a glass network and/or a glass matrix of the inorganic glass comprising a copper component. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. In some embodiments the Cu¹⁺ crystals include cuprite (Cu₂O). In such embodiments, where Cu¹⁺ crystals are present, the material may be referred to as a copper-containing glass ceramic, which is intended to refer to a specific type of glass with crystals that may or may not be subjected to a traditional ceramming process by which one or more crystalline phases are introduced and/or generated in the glass. Where the Cu¹⁺ ions are present in a non-crystalline form, the material may be referred to as a copper-containing glass. In some embodiments, both Cu¹⁺ crystals and Cu¹⁺ ions not associated with a crystal are present in the copper-containing glasses described herein.

According to embodiments of the present disclosure, the copper-containing glass may be formed from a glass composition that can include, in mole percent, SiO₂ in the range from about 30 to about 70, Al₂O₃ in the range from about 0 to about 20, a copper-containing oxide in the range from about 10 to about 50, CaO in the range from about 0 to about 15, MgO in the range from about 0 to about 15, P₂O₅ in the range from about 0 to about 25, B₂O₃ in the range from about 0 to about 25, K₂O in the range from about 0 to about 20, ZnO in the range from about 0 to about 5, Na₂O in the range from about 0 to about 20, and/or Fe₂O₃ in the range from about 0 to about 5. In such embodiments, the amount of the copper-containing oxide is greater than the amount of Al₂O_{3.} In some embodiments, the glass composition may include a content of R₂O, where R may include K, Na, Li, Rb, Cs and combinations thereof.

The copper-containing glasses described herein may include SiO₂ as the primary glass-forming oxide. The amount of SiO₂ present in a glass composition should be enough to provide glasses that exhibit the requisite chemical durability suitable for its use or application (e.g., touch applications, article housing etc.). The upper limit of SiO₂ may be selected to control the melting temperature of the glass compositions described herein. For example, excess SiO₂ could drive the melting temperature at 200 poise to high temperatures at which defects such as fining bubbles may appear or be generated during processing and in the resulting glass. Furthermore, compared to most oxides, SiO₂ decreases the compressive stress created by an ion exchange process of the resulting glass. In other words, glass formed from glass compositions with excess SiO₂ may not be ion-exchangeable to the same degree as glass formed from glass compositions without excess SiO₂. Additionally or alternatively, SiO₂ present in the glass compositions could increase the plastic deformation prior break properties of the resulting glass. An increased SiO₂ content in the glass formed from the glass compositions described herein may also increase the indentation fracture threshold of the glass.

The copper-containing glasses may include SiO₂ in an amount, in mole percent, in the range from about 30 to about 70, from about 30 to about 69, from about 30 to about 68, from about 30 to about 67, from about 30 to about 66, from about 30 to about 65, from about 30 to about 64, from about 30 to about 63, from about 30 to about 62, from about 30 to about 61, from about 30 to about 60, from about 40 to about 70, from about 45 to about 70, from about 46 to about 70, from about 48 to about 70, from about 50 to about 70, from about 41 to about 69, from about 42 to about 68, from about 43 to about 67 from about 44 to about 66 from about 45 to about 65, from about 46 to about 64, from about 47 to about 63, from about 48 to about 62, from about 49 to about 61, from about 50 to about 60 and all ranges and sub-ranges therebetween.

The copper-containing glasses may include Al₂O₃ an amount, in mole percent, in the range from about 0 to about 20, from about 0 to about 19, from about 0 to about 18, from about 0 to about 17, from about 0 to about 16, from about 0 to about 15, from about 0 to about 14, from about 0 to about 13, from about 0 to about 12, from about 0 to about 11 from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition is substantially free of Al₂O_{3.} As used herein, the phrase “substantially free” with respect to the components of the glass composition and/or resulting glass means that the component is not actively or intentionally added to the glass compositions during initial batching or subsequent post processing (e.g., ion exchange process), but may be present as an impurity. For example, a glass composition may be described as being substantially free of a component, when the component is present in an amount of less than about 0.01 mol %.

The amount of Al₂O₃ may be adjusted to serve as a glass-forming oxide and/or to control the viscosity of molten glass compositions. Without wishing to be bound by theory, it is believed that when the concentration of alkali oxide (R₂O) in a glass composition is equal to or greater than the concentration of Al₂O₃, the aluminum ions are found in tetrahedral coordination with the alkali ions acting as charge-balancers. This tetrahedral coordination greatly enhances various post-processing (e.g., ion exchange process) of glasses formed from such glass compositions. Divalent cation oxides (RO) can also charge balance tetrahedral aluminum to various extents. While elements such as calcium, zinc, strontium, and barium behave equivalently to two alkali ions, the high field strength of magnesium ions causes them to not fully charge balance aluminum in tetrahedral coordination, resulting in the formation of five- and six-fold coordinated aluminum. Generally, Al₂O₃ can play an important role in ion-exchangeable glass compositions and strengthened glasses since it enables a strong network backbone (e.g., high strain point) while allowing for the relatively fast diffusivity of alkali ions. However, when the concentration of Al₂O₃ is too high, the glass composition may exhibit lower liquidus viscosity and, thus, Al₂O₃ concentration may be controlled within a reasonable range. Moreover, as will be discussed in more detail below, excess Al₂O₃ has been found to promote the formation of Cu²⁺ ions, instead of the desired Cu¹⁺ ions.

The copper-containing glasses may include a copper-containing oxide in an amount, in mole percent, in the range from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21 and all ranges and sub-ranges therebetween. According to embodiments of the present disclosure, the copper-containing oxide may be present in the copper-containing glasses in an amount of about 20 mole percent, about 25 mole percent, about 30 mole percent or about 35 mole percent. The copper-containing oxide may include CuO, Cu₂O and/or combinations thereof.

The copper-containing oxides in the copper-containing glasses form the Cu¹⁺ ions present in the resulting glass. Copper may be present in the glass composition and/or the glasses including the glass composition in various forms including Cu⁰, Cu¹⁺, and Cu²⁺. Copper in the Cu⁰ or Cu¹⁺ forms provide antimicrobial activity. However, forming and maintaining these states of antimicrobial copper are difficult and often, in known glass compositions, Cu²⁺ ions are formed instead of the desired Cu⁰ or Cu¹⁺ ions.

The amount of copper-containing oxide in the copper-containing glasses may be greater than the amount of Al₂O₃ in the glass composition. Without wishing to be bound by theory it is believed that an about equal amount of copper-containing oxides and Al₂O₃ in the glass composition results in the formation of tenorite (CuO) instead of cuprite (Cu₂O). The presence of tenorite decreases the amount of Cu¹⁺ in favor of Cu²⁺ and thus leads to reduced antimicrobial activity. Moreover, when the amount of copper-containing oxides is about equal to the amount of Al₂O₃, aluminum prefers to be in a four-fold coordination and the copper in the glass composition and resulting glass remains in the Cu²⁺ form so that the charge remains balanced. Where the amount of copper-containing oxide exceeds the amount of Al₂O₃, then it is believed that at least a portion of the copper is free to remain in the Cu¹⁺ state, instead of the Cu²⁺ state, and thus the presence of Cu¹⁺ ions increases.

The copper-containing glasses may also include P₂O₅ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition includes about 10 mole percent or about 5 mole percent P₂O₅ or, alternatively, may be substantially free of P₂O₅.

The P₂O₅ in the copper-containing glasses may form at least part of a less durable phase or a degradable phase in the glass. The relationship between the degradable phase(s) of the glass and antimicrobial activity is discussed in greater detail herein. According to embodiments of the present disclosure, the amount of P₂O₅ may be adjusted to control crystallization of the glass composition and/or glass during forming. For example, when the amount of P₂O₅ is limited to about 5 mol % or less or even 10 mol % or less, crystallization may be minimized or controlled to be uniform. However, the amount or uniformity of crystallization of the glass composition and/or glass may not be of concern and thus, the amount of P₂O₅ utilized in the glass composition may be greater than 10 mol %.

Optionally, the amount of P₂O₅ in the glass composition may be adjusted based on the desired damage resistance of the glass, despite the tendency for P₂O₅ to form a less durable phase or a degradable phase in the glass. Without wishing to be bound by theory, P₂O₅ can decrease the melting viscosity relative to SiO₂. In some instances, P₂O₅ is believed to help suppress zircon breakdown viscosity (e.g., the viscosity at which zircon breaks down to form ZrO₂) and may be more effective in this regard than SiO₂. When glass is to be chemically strengthened via an ion exchange process, P₂O₅ can improve the diffusivity and decrease ion exchange times, when compared to other components that are sometimes characterized as network formers (e.g., SiO₂ and/or B₂O₃).

The glass composition of one or more embodiments includes B₂O₃ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition includes a non-zero amount of B₂O₃, which may be, for example, about 10 mole percent or about 5 mole percent. The glass composition of some embodiments may be substantially free of B₂O₃.

In one or more embodiments, B₂O₃ forms a less durable phase or a degradable phase in the glass formed form the glass composition. The relationship between the degradable phase(s) of the glass and antimicrobial activity is discussed in greater detail herein. Without being bound by theory, it is believed the inclusion of B₂O₃ in glass compositions imparts damage resistance in glasses incorporating such glass compositions, despite the tendency for B₂O₃ to form a less durable phase or a degradable phase in the glass. The glass composition of one or more embodiments includes one or more alkali oxides (R₂O) (e.g., Li₂O, Na₂O, K₂O, Rb₂O and/or Cs₂O). In some embodiments, the alkali oxides modify the melting temperature and/or liquidus temperatures of such glass compositions. In one or more embodiments, the amount of alkali oxides may be adjusted to provide a glass composition exhibiting a low melting temperature and/or a low liquidus temperature. Without being bound by theory, the addition of alkali oxide(s) may increase the coefficient of thermal expansion (CTE) and/or lower the chemical durability of the copper-containing glasses that include such glass compositions. In some cases these attributes may be altered dramatically by the addition of alkali oxide(s).

In some embodiments, the copper-containing glasses disclosed herein may be chemically strengthened via an ion exchange process in which the presence of a small amount of alkali oxide (such as Li₂O and Na₂O) is required to facilitate ion exchange with larger alkali ions (e.g., K⁺), for example exchanging smaller alkali ions from an copper-containing glass with larger alkali ions from a molten salt bath containing such larger alkali ions. Three types of ion exchange can generally be carried out. One such ion exchange includes a Na⁺-for-Li⁺ exchange, which results in a deep depth of layer but low compressive stress. Another such ion exchange includes a K⁺-for-Li⁺ exchange, which results in a small depth of layer but a relatively large compressive stress. A third such ion exchange includes a K⁺-for-Na⁺ exchange, which results in intermediate depth of layer and compressive stress. A sufficiently high concentration of the small alkali oxide in glass compositions may be necessary to produce a large compressive stress in the copper-containing glass including such glass compositions, since compressive stress is proportional to the number of alkali ions that are exchanged out of the copper-containing glass.

In one or more embodiments, the glass composition includes K₂O in an amount in the range from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition includes a non-zero amount of K₂O or, alternatively, the glass composition may be substantially free, as defined herein, of K₂O. In addition to facilitating ion exchange, where applicable, in one or more embodiments, K₂O can also form a less durable phase or a degradable phase in the glass formed form the glass composition. The relationship between the degradable phase(s) of the glass and antimicrobial activity is discussed in greater detail herein.

In one or more embodiments, the glass composition includes Na₂O in an amount in the range from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition includes a non-zero amount of Na₂O or, alternatively, the glass composition may be substantially free, as defined herein, of Na₂O.

In one or more embodiments, the glass composition may include one or more divalent cation oxides, such as alkaline earth oxides and/or ZnO. Such divalent cation oxides may be included to improve the melting behavior of the glass compositions. With respect to ion exchange performance, the presence of divalent cations can act to decrease alkali mobility and thus, when larger divalent cation oxides are utilized, there may be a negative effect on ion exchange performance. Furthermore, smaller divalent cation oxides generally help the compressive stress developed in an ion-exchanged glass more than the larger divalent cation oxides. Hence, divalent cation oxides such as MgO and ZnO can offer advantages with respect to improved stress relaxation, while minimizing the adverse effects on alkali diffusivity.

In one or more embodiments, the glass composition includes CaO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition is substantially free of CaO.

In one or more embodiments, the glass composition includes MgO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition is substantially free of MgO.

The glass composition of one or more embodiments may include ZnO in an amount, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition is substantially free of ZnO.

The glass composition of one or more embodiments may include Fe₂O₃, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition is substantially free of Fe₂O₃.

In one or more embodiments, the glass composition may include one or more colorants. Examples of such colorants include NiO, TiO₂, Fe₂O₃, Cr₂O₃, Co₃O₄ and other known colorants. In some embodiments, the one or more colorants may be present in an amount in the range up to about 10 mol %. In some instances, the one or more colorants may be present in an amount in the range from about 0.01 mol % to about 10 mol %, from about 1 mol % to about 10 mol %, from about 2 mol % to about 10 mol %, from about 5 mol % to about 10 mol %, from about 0.01 mol % to about 8 mol %, or from about 0.01 mol % to about 5 mol %.

In one or more embodiments, the glass composition may include one or more nucleating agents. Exemplary nucleating agents include TiO₂, ZrO₂ and other known nucleating agents in the art. The glass composition can include one or more different nucleating agents. The nucleating agent content of the glass composition may be in the range from about 0.01 mol % to about 1 mol %. In some instances, the nucleating agent content may be in the range from about 0.01 mol % to about 0.9 mol %, from about 0.01 mol % to about 0.8 mol %, from about 0.01 mol % to about 0.7 mol %, from about 0.01 mol % to about 0.6 mol %, from about 0.01 mol % to about 0.5 mol %, from about 0.05 mol % to about 1 mol %, from about 0.1 mol % to about 1 mol %, from about 0.2 mol % to about 1 mol %, from about 0.3 mol % to about 1 mol %, or from about 0.4 mol % to about 1 mol %, and all ranges and sub-ranges therebetween.

The copper-containing glasses formed from the glass compositions may include a plurality of Cu¹⁺ ions. In some embodiments, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., CuO and/or Cu₂O). Thus the Cu¹⁺ remains in an amorphous state and becomes part of the glass network. In some cases, the total amount of Cu¹⁺ ions, whether they are in a crystalline phase or in the glass matrix, may be even higher, such as up to 40 mol %, up to 50 mol %, or up to 60 mol %.

In one or more embodiments, the copper-containing glasses formed form the glass compositions disclosed herein include Cu¹⁺ ions that are dispersed in the glass matrix as Cu¹⁺ crystals. In one or more embodiments, the Cu¹⁺ crystals may be present in the form of cuprite. The cuprite present in the copper-containing glass may form a phase that is distinct from the glass matrix or glass phase. In other embodiments, the cuprite may form part of or may be associated with one or more glass phases (e.g., the durable phase described herein). The Cu¹⁺ crystals may have an average major dimension of about 5 micrometers (μm) or less, 4 micrometers (μm) or less, 3 micrometers (μm) or less, 2 micrometers (μm) or less, about 1.9 micrometers (μm) or less, about 1.8 micrometers (μm) or less, about 1.7 micrometers (μm) or less, about 1.6 micrometers (μm) or less, about 1.5 micrometers (μm) or less, about 1.4 micrometers (μm) or less, about 1.3 micrometers (μm) or less, about 1.2 micrometers (μm) or less, about 1.1 micrometers or less, 1 micrometers or less, about 0.9 micrometers (μm) or less, about 0.8 micrometers (μm) or less, about 0.7 micrometers (μm) or less, about 0.6 micrometers (μm) or less, about 0.5 micrometers (μm) or less, about 0.4 micrometers (μm) or less, about 0.3 micrometers (μm) or less, about 0.2 micrometers (μm) or less, about 0.1 micrometers (μm) or less, about 0.05 micrometers (μm) or less, and all ranges and sub-ranges therebetween. As used herein and with respect to the phrase “average major dimension”, the word “average” refers to a mean value and the word “major dimension” is the greatest dimension of the particle as measured by SEM. In some embodiments, the cuprite phase may be present in the copper-containing glass in an amount of at least about 10 wt %, at least about 15 wt %, at least about 20 wt %, at least about 25 wt % and all ranges and subranges therebetween of the copper-containing glass.

In some embodiments, the copper-containing glass may include about 70 wt % Cu¹⁺ or more and about 30 wt % of Cu²⁺ or less. The Cu²⁺ ions may be present in tenorite form and/or even in the glass (e.g., not as a crystalline phase).

In some embodiments, the total amount of Cu by wt % in the copper-containing glass may be in the range from about 10 to about 30, from about 15 to about 25, from about 11 to about 30, from about 12 to about 30, from about 13 to about 30, from about 14 to about 30, from about 15 to about 30, from about 16 to about 30, from about 17 to about 30, from about 18 to about 30, from about 19 to about 30, from about 20 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 16 to about 24, from about 17 to about 23, from about 18 to about 22, from about 19 to about 21 and all ranges and sub-ranges therebetween. In one or more embodiments, the ratio of Cu¹⁺ ions to the total amount Cu in the copper-containing glass is about 0.5 or greater, 0.55 or greater, 0.6 or greater, 0.65 or greater, 0.7 or greater, 0.75 or greater, 0.8 or greater, 0.85 or greater, 0.9 or greater or even 1 or greater, and all ranges and sub-ranges therebetween. The amount of Cu and the ratio of Cu¹⁺ ions to total Cu may be determined by inductively coupled plasma (ICP) techniques known in the art.

In some embodiments, the copper-containing glass may exhibit a greater amount of Cu¹⁺ and/or Cu0 than Cu²⁺. For example, based on the total amount of Cu¹⁺, Cu²⁺ and Cu0 in the glasses, the percentage of Cu¹⁺ and Cu⁰, combined, may be in the range from about 50% to about 99.9%, from about 50% to about 99%, from about 50% to about 95%, from about 50% to about 90%, from about 55% to about 99.9%, from about 60% to about 99.9%, from about 65% to about 99.9%, from about 70% to about 99.9%, from about 75% to about 99.9%, from about 80% to about 99.9%, from about 85% to about 99.9%, from about 90% to about 99.9%, from about 95% to about 99.9%, and all ranges and sub-ranges therebetween. The relative amounts of Cu¹⁺, Cu²⁺ and Cu⁰ may be determined using x-ray photoluminescence spectroscopy (XPS) techniques known in the art. The copper-containing glass comprises at least a first phase and second phase. In one or more embodiments, the copper-containing glass may include two or more phases wherein the phases differ based on the ability of the atomic bonds in the given phase to withstand interaction with a leachate. Specifically, the copper-containing glass of one or more embodiments may include a first phase that may be described as a degradable phase and a second phase that may be described as a durable phase. The phrases “first phase” and “degradable phase” may be used interchangeably. The phrases “second phase” and “durable phase” may be used interchangeably. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. Durable and degradable are relative terms, meaning that there is no explicit degradation rate above which a phase is durable and below which a phase is degradable, but rather, the durable phase is more durable than the degradable phase.

In one or more embodiments, the durable phase includes SiO₂ and the degradable phase includes at least one of B₂O₃, P₂O₅ and R₂O (where R can include any one or more of K, Na, Li, Rb, and Cs). Without wishing to be bound by theory, it is believed that the components of the degradable phase (e.g., B₂O₃, P₂O₅ and/or R₂O) more readily interact with a leachate and the bonds between these components to one another and to other components in the copper-containing glass more readily break during and after the interaction with the leachate. Leachates may include water, acids or other similar materials. In one or more embodiments, the degradable phase withstands degradation for 1 week or longer, 1 month or longer, 3 months or longer, or even 6 months or longer. In some embodiments, longevity may be characterized as maintaining antimicrobial efficacy over a specific period of time.

In one or more embodiments, the durable phase is present in an amount by weight that is greater than the amount of the degradable phase. In some instances, the degradable phase forms islands and the durable phase forms the sea surrounding the islands (e.g., the durable phase). In one or more embodiments, either one or both of the durable phase and the degradable phase may include cuprite. The cuprite in such embodiments may be dispersed in the respective phase or in both phases.

In some embodiments, phase separation occurs without any additional heat treatment of the copper-containing glass. In some embodiments, phase separation may occur during melting and may be present when the glass composition is melted at temperatures up to and including about 1600° C. or 1650° C. When the glass is cooled, the phase separation is maintained.

The copper-containing glass may be provided as a sheet or may have another shape such as particulate (which may be hollow or solid), fibrous, and the like. In one or more embodiments, the copper-containing glass includes a surface and a surface portion extending from the surface into the copper-containing glass at a depth of about 5.0 nanometers (nm) or less. The surface portion may include a plurality of copper ions wherein at least 75% of the plurality of copper ions include Cu¹⁺-ions. For example, in some instances, at least about 80%, at least about 85%, at least about 90%, at least about 95%, at least about 98%, at least about 99% or at least about 99.9% of the plurality of copper ions in the surface portion include Cu¹⁺ ions. In some embodiments, 25% or less (e.g., 20% or less, 15% or less, 12% or less, 10% or less or 8% or less) of the plurality of copper ions in the surface portion include Cu²⁺ ions. For example, in some instances, 20% or less, 15% or less, 10% or less, 5% or less, 2% or less, 1% or less, 0.5% or less or 0.01% or less of the plurality of copper ions in the surface portion include Cu²⁺ ions. In some embodiments, the surface concentration of Cu¹⁺ ions in the copper-containing glass is controlled. In some instances, a Cu¹⁺ ion concentration of about 4 ppm or greater can be provided on the surface of the copper-containing glass.

The copper-containing particles of one or more embodiments may exhibit a 2 log reduction or greater (e.g., 2.5, 3, 3.5, 4, 4.5, 5, 5.5, 6, 6.5 and all ranges and sub-ranges therebetween) in a concentration of at least one of Staphylococcus aureus, Enterobacter aerogenes, Pseudomomas aeruginosa, Methicillin Resistant Staphylococcus aureus, and E. coli, under the U.S. Environmental Protection Agency “Test Method for Efficacy of Copper Alloy as a Sanitizer” (2009) test (also referred to herein as the “EPA Test”). In some instances, the copper-containing particles exhibit at least a 4 log reduction, a 5 log reduction or even a 6 log reduction in the concentration of at least one of Staphylococcus aureus, Enterobacter aerogenes, Pseudomomas aeruginosa bacteria, Methicillin Resistant Staphylococcus aureus, and E. coli under the EPA Test.

The copper-containing particles described herein according to one or more embodiments may exhibit a 4 log reduction or greater (e.g., 5 log reduction or greater) in a concentration of at least one of Staphylococcus aureus, Enterobacter aerogenes, Pseudomomas aeruginosa bacteria, Methicillin Resistant Staphylococcus aureus, and E. coli, under JIS Z 2801 (2000) testing conditions. One or more embodiments of the copper-containing particles described herein may also exhibit a 4 log reduction or greater (e.g., 5 log reduction or greater) in a concentration of at least one of Staphylococcus aureus, Enterobacter aerogenes, Pseudomomas aeruginosa Methicillin Resistant Staphylococcus aureus, and E. coli, under the Modified JIS Z 2801 Test for Bacterial. As used herein, Modified JIS Z 2801 Test for Bacteria includes evaluating the bacteria under the standard JIS Z 2801 (2000) test with modified conditions comprising heating the glass or article to a temperature of about 23 degrees Celsius to about 37 degrees Celsius at a humidity of about 38 percent to about 42 percent for about 6 hours.

In one or more embodiments described herein, the copper-containing particles exhibit a 2 log reduction or greater, a 3 log reduction or greater, a 4 log reduction or greater, or a 5 log reduction or greater in Murine Norovirus under a Modified JIS Z 2801 for Viruses test. The Modified JIS Z 2801 (2000) Test for Viruses includes the following procedure. For each material (e.g., the copper-containing particles of one or more embodiments, control materials, and any comparative particles, coatings, or materials) to be tested, three samples of the material (contained in individual sterile petri dishes) are each inoculated with a 20 μL aliquot of a test virus (where antimicrobial activity is measured) or a test medium including an organic soil load of 5% fetal bovine serum with or without the test virus (where cytotoxicity is measured). The inoculum is then covered with a film and the film is pressed down so the test virus and/or or test medium spreads over the film, but does not spread past the edge of the film. The exposure time begins when each sample was inoculated. The inoculated samples are transferred to a control chamber set to room temperature (about 20° C.) in a relative humidity of 42% for 2 hours. Exposure time with respect to control samples are discussed below. Following the 2-hour exposure time, the film is lifted off using sterile forceps and a 2.00 mL aliquot of the text virus and/or test medium is pipetted individually onto each sample of material and the underside of the film (or the side of the film exposed to the sample) used to cover each sample. The surface of each sample is individually scraped with a sterile plastic cell scraper to collect the test virus or test medium. The test virus and/or test medium is collected (at 10⁻² dilution), mixed using a vortex type mixer and serial 10-fold dilutions are prepared. The dilutions are then assayed for antimicrobial activity and/or cytotoxicity.

To prepare a control sample for testing antimicrobial activity (which are also referred to as “zero-time virus controls”) for the Modified JIS Z 2801 Test for Viruses, three control samples (contained in individual sterile petri dishes) are each inoculated with a 20 μL aliquot of the test virus. Immediately following inoculation, a 2.00 mL aliquot of test virus is pipetted onto each control sample. The surface of each sample was individually scrapped with a sterile plastic cell scraper to collect test virus. The test virus is collected (at 10⁻² dilution), mixed using a vortex type mixer, and serial 10-fold dilutions were prepared. The dilutions are assayed for antimicrobial activity.

To prepare controls samples for cytotoxicity (which are also referred to as “2 hour control virus”) for the Modified JIS Z 2801 Test for Viruses, one control sample (contained in an individual sterile petri dish) is inoculated with a 20 μL aliquot of a test medium containing an organic soil load (5% fetal bovine serum), without the test virus. The inoculum is covered with a film and the film is pressed so the test medium spreads over the film but does not spread past the edge of the film. The exposure time begins when each control sample is inoculated. The control sample is transferred to a controlled chamber set to room temperature (20° C.) in a relative humidity of 42% for a duration of 2 hours exposure time. Following this exposure time, the film is lifted off using sterile forceps and a 2.00 mL aliquot of the test medium is pipetted individually onto each control sample and the underside of the film (the side exposed to the sample). The surface of each sample is individually scraped with a sterile plastic cell scraper to collect the test medium. The test medium is collected (at 10⁻² dilution), mixed using a vortex type mixer, and serial 10-fold dilutions were prepared. The dilutions were assayed for cytotoxicity.

The copper-containing particles of one or more embodiments may exhibit the log reduction described herein for long periods of time. In other words, the copper-containing particles may exhibit extended or prolonged antimicrobial efficacy. For example, in some embodiments, the copper-containing particles may exhibit the log reductions described herein under the EPA Test, the JIS Z 2801 (2000) testing conditions, the Modified JIS Z 2801 Test for Bacteria and/or the Modified JIS Z 2801 Test for Viruses for up to 1 month, up to 3 months, up to 6 months, or up to 12 months after the copper-containing particles are formed or after the copper-containing particles are combined with a carrier (e.g., polymers, monomers, binders, solvents and the like). These time periods may start at or after the copper-containing particles are formed or are combined with a carrier.

According to embodiments of the present disclosure, the copper-containing particles may exhibit a preservative function, when combined with carriers described herein. In such embodiments, the copper-containing particles may kill or eliminate, or reduce the growth of various foulants in the carrier. Foulants include fungi, bacteria, viruses, mold, mildew, algae and combinations thereof.

According to some embodiments of the present disclosure, the copper-containing particles and/or materials described herein leach the copper ions when exposed or in contact with a leachate. In one or more embodiments, the copper-containing particles leach only copper ions when exposed to leachates including water.

According to embodiments of the present disclosure, the copper-containing particles and/or articles described herein may have a tunable antimicrobial activity release. The antimicrobial activity of the glass and/or materials may be caused by contact between the copper-containing particles and a leachate, such as water, where the leachate causes Cu¹⁻ ions to be released from the copper-containing particles. This action may be described as water solubility and the water solubility can be tuned to control the release of the Cu⁺¹ ions.

In some embodiments, where the Cu¹⁺ ions are disposed in the glass network and/or form atomic bonds with the atoms in the glass network, water or humidity breaks those bonds and the Cu¹⁺ ions available for release and may be exposed on the glass or glass ceramic surface.

In one or more embodiments, the copper-containing glass may be formed using low cost melting tanks that are typically used for melting glass compositions such as soda lime silicate. The copper-containing glass may be formed into a sheet using forming processes known in the art. For instance, example forming methods include float glass processes and down-draw processes such as fusion draw and slot draw.

After formation, the copper-containing particles may be formed into sheets and may be shaped, polished or otherwise processed for a desired end use. In some instances, the copper-containing glass may be ground to a powder or particulate form. In other embodiments, the particulate copper-containing glass may be combined with other materials or carriers into articles for various end uses. The combination of the copper-containing glass and such other materials or carriers may be suitable for injection molding, extrusion or coatings or may be drawn into fibers.

In one or more embodiments, the copper-containing particles may include copper (I) oxide. The amount of copper (I) oxide in the particles may be up to 100%. In other words, the copper (I) oxide particles may exclude glass or a glass network.

In one or more embodiments, the copper-containing particles may have a diameter in the range from about 0.1 micrometers (μm) to about 10 micrometers (μm), from about 0.1 micrometers (μm) to about 9 micrometers (μm), from about 0.1 micrometers (μm) to about 8 micrometers (μm), from about 0.1 micrometers (μm) to about 7 micrometers (μm), from about 0.1 micrometers (μm) to about 6 micrometers (μm), from about 0.5 micrometers (μm) to about 10 micrometers (μm), from about 0.75 micrometers (μm) to about 10 micrometers (μm), from about 1 micrometers (μm) to about 10 micrometers (μm), from about 2 micrometers (μm) to about 10 micrometers (μm), from about 3 micrometers (μm) to about 10 micrometers (μm) from about 3 micrometers (μm) to about 6 micrometers (μm), from about 3.5 micrometers (μm) to about 5.5 micrometers (μm), from about 4 micrometers (μm), to about 5 micrometers (μm), and all ranges and sub-ranges therebetween. As used herein, the term “diameter” refers to the longest dimension of the particle. The particulate copper-containing glass may be substantially spherical or may have an irregular shape. The particles may be provided in a solvent and thereafter dispersed in a carrier as otherwise described herein.

In one or more embodiments, the copper-containing particles are present in an amount of about 150 g/gallon or less, about 125 g/gallon or less, about 100 g/gallon of carrier or less, about 75 g/gallon of carrier or less, or about 50 g/gallon of carrier or less.

In some instances, the copper-containing particles are present in an amount in the range of from about 1 g/gallon to about 150 g/gallon, about 1 g/gallon to about 125 g/gallon, about 1 g/gallon to about 100 g/gallon, about 2 g/gallon to about 150 g/gallon, about 2 g/gallon to about 125 g/gallon, about 2 g/gallon to about 100 g/gallon, about 4 g/gallon to about 150 g/gallon, about 4 g/gallon to about 125 g/gallon, about 4 g/gallon to about 100 g/gallon, about 5 g/gallon to about 150 g/gallon, about 5 g/gallon to about 125 g/gallon, about 5 g/gallon to about 100 g/gallon, about 10 g/gallon to about 150 g/gallon, about 10 g/gallon to about 125 g/gallon, about 10 g/gallon to about 100 g/gallon, about 15 g/gallon to about 150 g/gallon, about 15 g/gallon to about 125 g/gallon, about 15 g/gallon to about 100 g/gallon, about 20 g/gallon to about 150 g/gallon, about 20 g/gallon to about 125 g/gallon, about 20 g/gallon to about 100 g/gallon, about 1 g/gallon to about 150 g/gallon, about 30 g/gallon to about 125 g/gallon, about 30 g/gallon to about 100 g/gallon, about 50 g/gallon to about 150 g/gallon, about 50 g/gallon to about 125 g/gallon, about 50 g/gallon to about 100 g/gallon, about 75 g/gallon to about 150 g/gallon, about 75 g/gallon to about 125 g/gallon, about 75 g/gallon to about 100 g/gallon, about 1 g/gallon to about 75 g/gallon, from about 2 g/gallon to about 75 g/gallon, from about 4 g/gallon to about 75 g/gallon, from about 4 g/gallon to about 75 g/gallon, from about 5 g/gallon to about 75 g/gallon, from about 6 g/gallon to about 75 g/gallon, from about 7 g/gallon to about 75 g/gallon, from about 8 g/gallon to about 75 g/gallon, from about 9 g/gallon to about 75 g/gallon, from about 10 g/gallon to about 75 g/gallon, from about 15 g/gallon to about 75 g/gallon, from about 20 g/gallon to about 75 g/gallon, from about 30 g/gallon to about 75 g/gallon, from about 10 g/gallon to about 60 g/gallon, from about 10 g/gallon to about 50 g/gallon, from about 10 g/gallon to about 40 g/gallon, from about 10 g/gallon to about 30 g/gallon, from about 10 g/gallon to about 20 g/gallon, from about 20 g/gallon to about 50 g/gallon, from about 20 g/gallon to about 40 g/gallon, from about 20 g/gallon to about 30 g/gallon, from about 30 g/gallon to about 50 g/gallon, from about 35 g/gallon to about 50 g/gallon, or from about 40 g/gallon to about 50 g/gallon (all with reference to gallon of the carrier).

In some instances, the copper-containing particles are present in an amount in the range from about 1 g/gallon to about 50 g/gallon, from about 2 g/gallon to about 50 g/gallon, from about 3 g/gallon to about 50 g/gallon, from about 4 g/gallon to about 50 g/gallon, from about 5 g/gallon to about 50 g/gallon, from about 6 g/gallon to about 50 g/gallon, from about 7 g/gallon to about 50 g/gallon, from about 8 g/gallon to about 50 g/gallon, from about 9 g/gallon to about 50 g/gallon, from about 10 g/gallon to about 50 g/gallon, from about 15 g/gallon to about 50 g/gallon, from about 20 g/gallon to about 50 g/gallon, from about 30 g/gallon to about 50 g/gallon, from about 1 g/gallon to about 40 g/gallon, from about 1 g/gallon to about 30 g/gallon, from about 1 g/gallon to about 30 g/gallon, from about 1 g/gallon to about 20 g/gallon, from about 1 g/gallon to about 10 g/gallon, from about 2 g/gallon to about 50 g/gallon, from about 4 g/gallon to about 50 g/gallon, from about 4 g/gallon to about 40 g/gallon, from about 4 g/gallon to about 30 g/gallon, from about 4 g/gallon to about 20 g/gallon, or from about 4 g/gallon to about 10 g/gallon (all with reference to gallon of the carrier).

In one or more embodiments, the carrier may include polymers, monomers, binders, solvents, or a combination thereof as described herein. In a specific embodiment, the carrier is a paint that is used for application to surfaces (which may include interior or exterior surfaces). The paint can be a dispersion of finely divided solids in a liquid medium (e.g., water, organic solvent, and/or inorganic solvent) that can be applied to a surface to form a film that adheres to the surface. Examples of solids used in paints includes pigments, fillers, extenders, driers, rheology modifiers, etc. In some examples, the paint can be a latex paint. Examples of solvent include water and organic solvents.

The polymer used in the embodiments described herein can include a thermoplastic polymer, a polyolefin, a cured polymer, an ultraviolet- or UV-cured polymer, a polymer emulsion, a solvent-based polymer, and combinations thereof Examples of suitable polymers include, without limitation: thermoplastics including polystyrene (PS), high impact PS, polycarbonate (PC), nylon (sometimes referred to as polyamide (PA)), poly(acrylonitrile-butadiene-styrene) (ABS), PC-ABS blends, polybutyleneterephthlate (PBT) and PBT co-polymers, polyethyleneterephthalate (PET) and PET co-polymers, polyolefins (PO) including polyethylenes (PE), polypropylenes (PP), cyclicpolyolefins (cyclic-PO), modified polyphenylene oxide (mPPO), polyvinylchloride (PVC), acrylic polymers including polymethyl methacrylate (PMMA), thermoplastic elastomers (TPE), thermoplastic urethanes (TPU), polyetherimide (PEl) and blends of these polymers with each other. Suitable injection moldable thermosetting polymers include epoxy, acrylic, styrenic, phenolic, melamine, urethanes, polyesters, and silicone resins. In some embodiments, for example, when the carrier is in the form of a paint or coating, the polymer may be selected from acrylates, acrylic aliphatic urethanes, acrylic aromatic urethanes, alkyds, asphalt, bitumen, pitch, cationic polymers, cellulose-based polymers, chlorinated rubber, drying oil, epoxy, nitrocellulose, phenolic polymers, resins, plastisol, polyolefin dispersions, polyurethane, powdered coatings, p-vinyl butyral, saturated polyesters, shellac, silicate, silicone, silyl modified PU (SPUR), styrene, unsaturated polyester, urea, enzoguanamine, melamine resins, vinyl alkylate, vinyl chloride, vinyl fluoride, vinylidene chloride, vinylidene fluoride, and combinations thereof. The carrier may be include polymers and/or monomers in the absence of a solvent or in combination with a solvent. In other embodiments, the polymers may be dissolved in a solvent or dispersed as a separate phase in a solvent and form a polymer emulsion, such as a latex (which is a water emulsion of a synthetic or natural rubber, or plastic obtained by polymerization, and used especially in coatings (as paint) and adhesives). Polymers may include fluorinated silanes or other low friction or anti-frictive materials. The polymers can contain impact modifiers, flame retardants, UV inhibitors, antistatic agents, mold release agents, fillers including glass, metal or carbon fibers or particles (including spheres), talc, clay or mica and colorants. Specific examples of monomers include catalyst curable monomers, thermally-curable monomers, radiation-curable monomers, and combinations thereof.

To improve processability, mechanical properties and interactions between the carrier and the copper-containing particles described herein (including any fillers and/or additives that may be used), processing agents/aids may be included in the articles described herein. Exemplary processing agents/aids can include solid or liquid materials. The processing agents/aids may provide various extrusion benefits, and may include silicone based oil, wax, and free flowing fluoropolymer. In other embodiments, the processing agents/aids may include compatibilizers/coupling agents, e.g., organosilicon compounds such as organo-silanes/siloxanes that are typically used in processing of polymer composites for improving mechanical and thermal properties. Such compatibilizers/coupling agents can be used to surface modify the glass and can include (3-acryloxy-propyl)trimethoxysilane; N-(2-aminoethyl)-3-aminopropyltrimethoxysilane; 3-aminopropyltri-ethoxysilane; 3-aminopropyltrimethoxysilane; (3-glycidoxypropyl)trimethoxysilane; 3-mercapto-propyltrimethoxysilane; 3-methacryloxypropyltrimethoxysilane; and vinyltrimethoxysilane.

In some embodiments, the materials described herein may include fillers including pigments, that are typically metal based inorganics and can also be added for color and other purposes, e.g., aluminum pigments, copper pigments, cobalt pigments, manganese pigments, iron pigments, titanium pigments, tin pigments, clay earth pigments (naturally formed iron oxides), carbon pigments, antimony pigments, barium pigments, and zinc pigments.

After combining the copper-containing particles described herein with a carrier, as described herein, the combination or resulting material may be formed into a desired article or be applied to a surface. Where the material includes paint, the paint may be applied to a surface as a layer. Examples of such articles that may be formed using the material described herein include housings for electronic devices (e.g., mobile phones, smart phones, tablets, video players, information terminal devices, laptop computer, etc.), architectural structures (e.g., countertops, walls, trim, ceilings, floors, exterior facades, and trim), appliances (e.g., cooktops, refrigerator and dishwasher doors, etc.), information displays (e.g., whiteboards), and automotive components (e.g., dashboard panels, windshields, window components, etc.).

The materials described herein may include pigments to impart color. Accordingly, the coatings or layers made from such materials may exhibit a wide variety of colors, depending on the carrier color, mixture of carriers, and amount of particle loading. Moreover, the materials and/or coatings described herein showed no adverse effect to paint adhesion as measured by ASTM D4541. In some instances, the adhesion of the material or coating to an underlying substrate was greater than the cohesive strength of the substrate. In other words, in testing, the adhesion between the coating and the substrate was so strong that the underlying substrate failed before the coating was separated from the surface of the substrate. For example, where the substrate includes wood, the adhesion between the coating or layer and the substrate may be about 300 psi or greater, 400 psi or greater, 500 psi or greater, 600 psi or greater and all ranges-sub-ranges therebetween, as measured by ASTM D4541. In some instances, the material, when applied to a substrate as a coating or layer, exhibits an anti-sag index value of about 3 or greater, about 5 or greater, 7 or greater, 8 or greater, 9 or greater, 10 or greater, 11 or greater, 12 or greater, 13 or greater, 14 or greater or even 15 or greater, as measured by ASTM D4400.

The material and/or coating may exhibit sufficient durability for use in household and commercial applications. Specifically, the material, when applied to a substrate as a coating or layer, exhibits a scrub resistance as measured by ASTM D4213 of about 4 or greater, 5 or greater, 6 or greater, 7 or greater and all ranges and sub-ranges therebetween.

In one or more embodiments, the material and/or coating may be resistant to moisture. For example, after exposure of the material and/or coating to an environment of up to about 95% relative humidity for 24 hours, the material and/or coating exhibited no change in antimicrobial activity.

One or more embodiments of the material may include a copper-containing particles and a carrier with a loading level of the copper-containing particles such that the material exhibits resistance or preservation against the presence or growth of foulants. Foulants include fungi, bacteria, viruses, mold, mildew, algae, and combinations thereof. In some instances, the presence or growth of foulants in materials, such as paints, varnishes and the like, can cause color changes to the material, can degrade the integrity of the material and negatively affect various properties of the material. By including a minimum loading of copper-containing particles, (e.g., about 5 wt % or less, about 4 wt % or less, about 3 wt % or less, about 2 wt % or less, or about 1 wt % or less) to the carrier, the foulants can be eliminated or reduced. In some instances, the carrier formulation need not include certain components, when fouling is eliminated or reduced. Thus, the carrier formulations used in one or more embodiments of the materials described herein may have more flexibility and variations than previously possible, when used in known materials that do not include the copper-containing particles.

According to embodiments of the present disclosure, the biocidal material may include a carrier and treated copper-containing particles that have been pre-treated with a pretreatment solution including a copper-chelating material prior to combining the copper-containing particles with the carrier. Copper-containing particles that have been pretreated with the copper-chelating materials can be referred to as treated copper-containing particles. The treated copper-containing particles can be present in the pretreatment solution (e.g., dissolved and/or suspended therein), which can then be combined with the carrier, optionally without an intermediate step to separate the treated copper-containing particles from the pretreatment solution. The copper-chelating material can be any suitable material capable of interacting with copper to form a copper complex or a copper precipitate. The copper-chelating material can provide the treated copper-containing particles with a surface pretreatment. In some embodiments, the copper-chelating material can contain an amine-based material, an ammonia-based material, a hard base, an alkaline buffer solution, a group (I) hydroxide, a group (II) hydroxide, or combinations thereof. As used herein, unless otherwise specified, the term copper-chelating material refers to a material that can interact with copper to form monodentate ligands and/or multidentate ligands.

In some embodiments, the copper-chelating material contains an amine-based material. In some embodiments, the amine-based material can be an organic amine having the formula NR′R″R′″, where R′, R″, and R′″ are individually H, an alkyl, an alkanol, an aromatic alcohol, or a phenol group. As used herein, the term alkyl encompasses straight chain, branched, and cyclic alkyl groups. As used herein, the term alkanol encompasses straight chain, branched, and cyclic alkyl groups including at least one hydroxyl group. In some embodiments the amine-based material contains a primary, secondary, and/or tertiary amine. In some embodiments the amine-based material is an amino alcohol. In some embodiments, the amine-based material contains an organic amine having a single hydroxyl group (mono), two hydroxyl groups (diol), or three hydroxyl groups (triol). In some embodiments, the copper-chelating material can be a mono-amine, di-amine, tri-amine, or multi-amine compound. Examples of suitable organic amines include 2-amino-2-methyl-1-propanol, 2-dimethylamino-2-methyl-1-propanol, 2-butylaminoethanol, N-methylethanolamine, 2-amino-2-methyl-1-propanol, monoisopropanolamine, monoethanolamine, N,N-dimethylethanolamine, N-butyldiethanolamine, 2-amino-2-ethyl-1,3-propanediol, 2-amino-2-hydroxymethyl-1,3-propanediol, triethanolamine, 2-(methylamino)ethanol, 1-amino-2-propanol, 2-aminoethanol, 2-dimethylaminoethanol, 2-aminobenzyl alcohol, 2-amino-3-methylbenzyl alcohol, 2-amino-1-phenylethanol, 2-aminocyclohexanol, and triethylamine.

In some embodiments, the copper-chelating material contains an ammonia-based material, examples of which include ammonia and ammonium buffers. For example, the copper-chelating material can include ammonium chloride and/or ammonium phosphate. The ammonium buffers can be made using any suitable material or combination of materials to provide an ammonium buffer having the desired pH, examples of which include ammonium phosphate monobasic, ammonium phosphate dibasic, monoammonium phosphate (NH₄H₂PO₄), ammonium carbonate, and ammonium hydroxide.

In some embodiments, the copper-chelating material contains an ammonia-based and/or amine based solution having a pH of from about 8 to about 12, from about 8 to about 11, from about 8 to about 10, from about 8 to about 9, from about 9 to about 12, from about 9 to about 11, from about 9 to about 10, or from about 10 to about 12.

In some embodiments, the copper-chelating material can contain a group (I) hydroxide and/or a group (II) hydroxide. In some embodiments, the copper-chelating material contains a hard base, examples of which include potassium hydroxide and sodium hydroxide. The group (I) hydroxides, group (II) hydroxides, and/or hard base can be used alone or in combination with other materials to provide a composition adapted to react with copper when used to treat the copper-containing particles. In some embodiments, the group (I) hydroxides, group (II) hydroxides, and/or hard base are used to form a pre-treatment solution having a pH of at least 9.

In some embodiments, the copper-chelating material is an alkaline buffer containing one or more components that provide a desired pH and/or a desired chemical group (e.g., an amine-based or ammonium-based group). Examples of suitable alkaline buffers include phosphate buffers, borate buffers, ammonium buffers, carbonate buffers, and combinations thereof. For example, the alkaline buffer can include ammonium phosphate monobasic, potassium phosphate monobasic, ammonium phosphate dibasic, monoammonium phosphate (NH₄H₂PO₄), ammonium carbonate, ammonium hydroxide, boric acid, sodium borate, potassium chloride, sodium hydroxide, dihydrogen potassium phosphate, sodium phosphate dibasic, sodium phosphate monobasic, sodium phosphate tribasic, potassium phosphate tribasic, phosphoric acid, potassium phosphate dibasic, potassium phosphate monobasic, sodium carbonate, ammonium carbonate, potassium bicarbonate, sodium bicarbonate, and ammonium bicarbonate. In one example, the alkaline buffer contains dihydrogen potassium phosphate and sodium phosphate dibasic. In another example, the alkaline buffer contains potassium phosphate monobasic and sodium hydroxide. In yet another, the alkaline buffer contains boric acid, potassium chloride, and sodium hydroxide. In still another example, the alkaline buffer contains ammonium chloride, ammonium phosphate monobasic, and potassium phosphate monobasic. In some embodiments, the alkaline buffer has a pH of at least 9. For example, the alkaline buffer can have a pH of at least 9, at least 9.5, at least 10, at least 10.5, or at least 11. In some examples, the alkaline buffer can have a pH of about 9 to about 12, about 9.5 to about 12, about 10 to about 12, about 10.5 to about 12, about 11 to about 12, about 9 to about 11.5, about 9.5 to about 11.5, about 10 to about 11.5, about 10.5 to about 11.5, about 11 to about 11.5, 9 to about 11, about 9.5 to about 11, about 10 to about 11, about 10.5 to about 11, about 9 to about 10.5, about 9.5 to about 10.5, about 10 to about 10.5, about 9 to about 10, or about 9.5 to about 10.

The pretreatment solution may have a pH of between about 7 and about 12. For example, the pretreatment solution may have a pH of between about 8 and about 12, or between about 8.5 and about 10.5. In some examples, the pretreatment solution can have a pH of from about 7 to about 12, about 7 to about 11.5, about 7 to about 11, about 7 to about 10.5, about 7 to about 10, about 7 to about 9.5, about 7 to about 9, about 7 to about 8, about 7.5 to about 12, about 7.5 to about 11.5, about 7.5 to about 11, about 7.5 to about 10.5, about 7.5 to about 10, about 7.5 to about 9.5, about 7.5 to about 9, about 7.5 to about 8, about 8 to about 12, about 8 to about 11.5, about 8 to about 11, about 8 to about 10.5, about 8 to about 10, about 8 to about 9.5, about 8 to about 9, about 8.5 to about 12, about 8.5 to about 11.5, about 8.5 to about 11, about 8.5 to about 10.5, about 8.5 to about 10, about 8.5 to about 9.5, about 8.5 to about 9, about 9 to about 12, about 9 to about 11.5, about 9 to about 11, about 9 to about 10.5, about 9 to about 10, about 9 to about 9.5, about 9.5 to about 12, about 9.5 to about 11.5, about 9.5 to about 11, about 9.5 to about 10.5, about 9.5 to about 10, about 10 to about 12, about 10 to about 11.5, or about 10 to about 11.

In some embodiments, an amount and/or a pH of the pretreatment solution may be selected such that a pH of the combined mixture of the carrier and the treated copper-containing particles (e.g., the copper-containing particles that have already been treated with the pretreatment solution) is within a predetermined range of an initial pH of the carrier (e.g., the pH of the carrier prior to combining with the treated copper-containing particles). For example, in some embodiments, an amount and/or a pH of the pretreatment solution used to treat the copper-containing particles may be selected such that the pH of the mixture of the carrier and the treated copper-containing particles is within ±1 units of the initial pH of the carrier. In some embodiments, an amount and/or a pH of the pretreatment solution used to treat the copper-containing particles may be selected such that the pH of the mixture of the carrier and the treated copper-containing particles is within ±0.5, or even ±0.3 units of the initial pH of the carrier. Without wishing to be limited by any theory, it is believed that in some applications, the addition of a solution or a suspension of treated copper-containing particles that significantly affects the total volume and/or pH of the carrier may result in an undesirable change in one or more characteristics of the carrier. For example, when the carrier is a paint, large changes in volume and/or pH following the addition of the treated copper-containing particles, may undesirably affect other components of the paint or properties of the paint, such as the color or dispersion of one or more materials in the paint (e.g., pigment dispersion).

The copper-containing particles material may be treated in the pretreatment solution for any amount of time, for example, between about 5 minutes and about 24 hours, or between about 1 hour and about 12 hours, and all ranges and sub-ranges therebetween. In some embodiments, the copper-containing particles can be pretreated in the pretreatment solution for greater than 5 minutes, greater than 10 minutes, greater than 1 hour, greater than 2 hours, greater than 5 hours, greater than 10 hours, greater than 15 hours, greater than 20 hours, greater than 24 hours, or greater than 48 hours. For example, the copper-containing particles can be pretreated in the pretreatment solution for from about 5 minutes to about 72 hours, about 5 minutes to about 48 hours, about 5 minutes to about 36 hours, about 5 minutes to about 24 hours, about 5 minutes to about 20 hours, about 5 minutes to about 10 hours, about 5 minutes to about 5 hours, about 5 minutes to about 2 hours, about 10 minutes to about 72 hours, about 10 minutes to about 48 hours, about 10 minutes to about 36 hours, about 10 minutes to about 24 hours, about 10 minutes to about 20 hours, about 10 minutes to about 10 hours, about 10 minutes to about 5 hours, about 10 minutes to about 2 hours, about 60 minutes to about 72 hours, about 60 minutes to about 48 hours, about 60 minutes to about 36 hours, about 60 minutes to about 24 hours, about 60 minutes to about 20 hours, about 60 minutes to about 10 hours, about 60 minutes to about 5 hours, about 60 minutes to about 2 hours, about 2 hours to about 72 hours, about 2 hours to about 48 hours, about 2 hours to about 36 hours, about 2 hours to about 24 hours, about 2 hours to about 20 hours, about 2 hours to about 10 hours, about 2 hours to about 5 hours, about 5 hours to about 72 hours, about 5 hours to about 48 hours, about 5 hours to about 36 hours, about 5 hours to about 24 hours, about 5 hours to about 20 hours, about 5 hours to about 10 hours, about 10 hours to about 72 hours, about 10 hours to about 48 hours, about 10 hours to about 36 hours, about 10 hours to about 24 hours, about 10 hours to about 20 hours, about 20 hours to about 72 hours, about 20 hours to about 48 hours, about 20 hours to about 36 hours, about 20 hours to about 24 hours, about 24 hours to about 72 hours, or about 24 hours to about 48 hours. In some examples, the copper-containing particles can be treated in the pretreatment solution for a predetermined period of time and then immediately combined with the carrier. In other examples, the copper-containing particles can be treated in the pretreatment solution for a minimum period of time and immediately combined with the carrier and/or stored for a period of time before combining with the carrier. In some embodiments, the mixture of the treated copper-containing particles and the pretreatment solution can be combined directly with the carrier without an intermediate step to separate the treated copper-containing particles from the pretreatment solution. In some embodiments, following the pretreatment period, the mixture of the treated copper-containing particles and the pretreatment solution may be combined with one or more additional materials (e.g., a solvent or additional buffer), prior to combining the mixture with the carrier.

Without wishing to be bound by any particular theory, it is believed that as portions of the copper-containing particles dissolve during or after being combined with a carrier, more of the compositional components of the copper-containing particles are released and become available to interact with the components of the carrier. Some of these dissolved components, such as copper ions, may cause changes in a color of the carrier at the time of combining the treated copper-containing particles and the carrier and/or for a predetermined period of time after combining the treated copper-containing particles and the carrier.

According to some embodiments of the present disclosure, the copper-containing particles described herein may exhibit higher solubility at a pH of greater than 7, which may result in a greater amount of the components of the material being released from the copper-containing particles when pretreated in the pretreatment solution containing the copper-chelating material prior to being combined with a carrier. For example, copper-containing glass particles as described herein were mixed to form three separate solutions with (i) a non-buffered ammonia having a pH of 9, (ii) a non-buffered ammonia having a pH of 11, and (iii) a non-buffered ammonia having a pH of 12. After four hours of soaking, the amount of copper released from the copper-containing glass material was measured and the color of the supernatant was visually inspected. The results, which are included in Table 1 below, show that the amount of copper released from the copper-containing glass particles increased as the pH of the solution increased.

TABLE 1

| Ammonia pH | Cu (ppm) | Supernatant Color |
|---|---|---|
| 9 | 2 | Colorless |
| 11 | 530 | Blue |
| 12 | 2100 | Deep Blue |

Without wishing to be limited by any theory, it is believed that treated copper-containing particles that have been pre-treated with a copper-chelating material as described herein can provide complexing or precipitating agents which, when combined with a carrier, may reduce or eliminate the formation of copper-based complexes that would otherwise cause changes to the color of the carrier. As one example, when copper-containing glass particles are pretreated with monoammonium phosphate, a copper-based complex of Cu(H₂PO₄)₂ and/or Cu(H₂PO₄)⁻² may be formed which stabilizes the copper ions released from the copper-containing glass particles and may prevent formation of other copper-based complexes that would otherwise cause changes to the color of the carrier.

In some embodiments, the formation of a colored solution and/or a precipitate when the copper-containing particles are combined with the pretreatment solution may be indicative of an ability of the treated copper-containing particles to stabilize the color of the carrier compared to untreated copper-containing particles. Stabilizing the color of the carrier can include decreasing a shift in a color of the carrier after mixing and/or decreasing a drift in a color of the carrier over time after mixing and/or increasing a rate of color change such that the color of the mixture stabilizes quicker (which may involve a large initial change in color). For example, in paint applications, when copper is added to the paint, the copper may affect the color of the paint when initially mixed and/or may affect the color of the paint over time as it is stored and/or after use. In some embodiments, the treated copper-containing particles result in a decrease in the color change of the mixture, an initial color change and/or over time, compared to untreated copper-containing particles. In some embodiments, pretreating the copper-containing particles of the present disclosure before combining the particles with a paint may accelerate the color change of the paint. Accelerating the color change of the paint during the manufacturing process of the paint can allow the manufacturer to account for the color change induced by the treated copper-containing particles and thus facilitate providing a final product having a desired color and improved color stability over time. Thus, in some embodiments, an acceleration in the color change of the carrier when combined with the treated copper-containing particles can be utilized by manufacturers to account for the color change and adjust accordingly during the manufacturing process. In addition, in some embodiments, the majority of the color change occurs during the manufacturing process and thus the final paint product may have improved color stability during storage and/or after use. In other embodiments, the treated copper-containing particles may result in a decrease in the color change of the carrier and/or an increase in the stability of the color of the carrier over time as compared to untreated copper-containing particles (e.g., copper-containing particles that have not been pretreated with a pretreatment solution containing a copper-chelating material as described herein).

### EXAMPLES

Embodiments of the present disclosure are further described below with respect to certain exemplary and specific embodiments thereof, which are illustrative only and not intended to be limiting.

### Example I

Various concentrations of the copper-containing glass particles as described herein were exposed to a pretreatment media for about 1 hour. The pretreated copper-containing glass particles were then incorporated into a carrier product, in this example a latex paint, to form mixed carrier products. The mixed carrier products were tested “in-can” for color shift and color drift as compared to a Control Example (Control A) which was a latex paint that did not include any copper-containing glass particles. The mixed carrier products were each stored “in-can” for about 72 hours. Data for the various mixed carrier products is shown in Table 2 as Examples 1-12 along with data for Control A.

As used herein, unless otherwise specified, the term “color shift,” is used to refer to the change of the color of the carrier upon addition of the copper-containing particles and compares the color of the mixed carrier and copper-containing particles to the color of the carrier in the absence of the copper-containing particles (control). The term “color drift” is used to refer to the change of the color of the carrier at a predetermined time after addition of the copper-containing particles and compares the color of the carrier mixed with the copper-containing particles after a predetermined time period to the color of the carrier upon initially being mixed with the copper-containing particles (time=0). Color shift and color drift can be reported using ΔE*. Color shift and color drift can be reported in terms of ΔE_{c}* and ΔE₀*according to formulas (I) and (II), respectively,:

ΔE_{c}*={square root over (((L*−L*_{control})²+(a*−a*_{control})²+(b*−b*_{control})²))} (I)

ΔE*₀={square root over (((L*−L*₀)²+(a*−a*₀)²+(b*−b*₀)²))} (II)

where L*, a*, and b* are the CIE L*, a*, and b* values of the mixed carrier material, L*_{control}, a*_{control}, and b*_{control} are the CIE L*, a*, and b* values of the carrier in the absence of the copper-containing particles, and L*₀, a*₀, and b*₀ are the CIE L*, a*, and b* values of the mixed carrier material at the time of mixing (time=0).

In some embodiments, color drift can be reported in terms of an LCh° factor. For example, a percent change of the coordinates L*, C* and h° per day can be calculated as the difference between the coordinates measured at the time of adding the copper-containing particles to the carrier products and the same coordinates measured at some predetermined time period (e.g., time (t)=72 hours) after adding the copper-containing particles to the carrier products to arrive at values for the percent change of the components per day dL*, dC* and dh°. Formulas (III)-(V) can be used to determine dL*, dC* and dh°, respectively:

dL*=((Lₜ*−L₀*)×24)/(t×L₀*) (III)

dC*=((Cₜ*−C₀*)×24)/(t×C₀*) (IV)

dh°=((h°ₜ−h°₀)×24)/(t×h°₀) (V)

where Lₜ*, Cₜ*, and h°ₜ are the CIE L*, C*, and h° values of the mixed carrier material at a predetermined time period after mixing and L*₀, C*₀, and h°₀ are the CIE L*, C*, and h° values of the mixed carrier material at the time of mixing (time=0). Color drift can be reported in terms of an LCh° factor according to formula (VI):

LCh°={square root over (((dL*)²+(dC*)²+(dh°)²) )} (VI)

where dL*, dC*, and dh° are determined according to formulas (III)-(V) above.

The pretreatment medias used in Examples 1-12 included: ammonium chloride buffer (AC); ammonium phosphate buffer (AP); and 2-amino-2-methy-1-propanol (AMP-95™). AMP-95™ is a 90 wt % 2-amino-methyl-1-propanol solution containing 5 wt % added water (available from Sigma-Aldrich).

The resulting mixed carriers were applied to a plastic substrate and dried for 24 hours. The log reduction was measured in a concentration of Staphylococcus aureus, under the EPA Test (U.S. Environmental Protection Agency “Test Method for Efficacy of Copper Alloy as a Sanitizer” (2009)) for each mixed carrier product.

TABLE 2

| | Copper- | | | | | | |
|---|---|---|---|---|---|---|---|
| | Containing | | Pretreatment | Mixed | | | |
| | Glass | Pretreatment | Media | Carrier | | LCh° | Log |
| Example | (g/gal) | Media | pH | pH | ΔE_{c}* | Factor | Reduction |
| Control A | 0 | None | N/A | 9.46 | N/A | N/A | 0.42 |
| Ex. 1 | 25 | None | N/A | 9.04 | 3.89 | 8% | 0.42 |
| Ex. 2 | 25 | AC | 10.5 | 9.86 | 4.10 | 1% | 2.97 |
| Ex. 3 | 25 | AMP-95 | Conc. (5%) | 9.59 | 3.96 | 4% | 4.81 |
| Ex. 4 | 25 | AP | 10.5 | 9.82 | 3.80 | 1% | 2.00 |
| Ex. 5 | 50 | None | N/A | 8.93 | 5.99 | 7% | 4.81 |
| Ex. 6 | 50 | AC | 10.5 | 9.77 | 5.83 | 1% | 4.81 |
| Ex. 7 | 50 | AMP-95 | Conc. (5%) | 9.36 | 5.89 | 6% | 4.81 |
| Ex. 8 | 50 | AP | 10.5 | 9.76 | 5.70 | 1% | 4.81 |
| Ex. 9 | 75 | None | N/A | 8.90 | 7.80 | 7% | 4.81 |
| Ex. 10 | 75 | AC | 10.5 | 9.75 | 7.18 | 2% | 4.81 |
| Ex. 11 | 75 | AMP-95 | Conc. (5%) | 9.30 | 7.67 | 6% | 4.81 |
| Ex. 12 | 75 | AP | 10.5 | 9.71 | 7.25 | 3% | 4.81 |

Table 3 shows the percent change per day for the E_{c}*, L*, C* and h° values for Ex. 1-12, normalized with respect to that value at 0 hours in-can.

TABLE 3

| Example | dE_{c}* | dL* | dC* | dh° |
|---|---|---|---|---|
| Control A | — | — | — | — |
| Ex. 1 | −3% | 0%x | 0% | 8% |
| Ex. 2 | 0% | 0% | 1% | 0% |
| Ex. 3 | −1% | 0% | 3% | 3% |
| Ex. 4 | 1% | 0% | 1% | 0% |
| Ex. 5 | −2% | 0% | −1% | 7% |
| Ex. 6 | 0% | 0% | 1% | 0% |
| Ex. 7 | −2% | 0% | 0% | 6% |
| Ex. 8 | 0% | 0% | 1% | 0% |
| Ex. 9 | −3% | 0% | −2% | 6% |
| Ex. 10 | 0% | 0% | 2% | 0% |
| Ex. 11 | −1% | 0% | −1% | 6% |
| Ex. 12 | 0% | 0% | 2% | 2% |

As shown in Table 2, pretreatment as described herein resulted in a reduction in color drift (as measured by the LCh° factor) as compared to non-pretreated examples (Ex. 1, 5, and 9) having the same concentration of copper-containing glass particles. This is especially noticeable in the examples where the copper-containing glass particles were pretreated with ammonium chloride buffer (AC) and ammonium phosphate buffer (AP).

### Example II

Mixed carrier products were formed in accordance with the above-described examples in Example I. 75 g/gal of the copper-containing glass particles were exposed to pretreatment media for various time periods. The pretreated copper-containing glass particles were then incorporated into a carrier product to form mixed carrier products. The mixed carrier products were tested “in-can” for color shift and color drift as compared to a Control Example (Control B) which was a carrier product that did not include any copper-containing glass particles. The mixed carrier products were each stored “in-can” for between about 120 hours and about 126 hours. Data for the various mixed carrier products is shown in Table 4 as Examples 13-23 along with data for Control B.

TABLE 4

| | | Pre- | | Pre- | | | | |
|---|---|---|---|---|---|---|---|---|
| | Pre- | treatment | Media | treatment | Mixed | | | |
| | treatment | Time | Volume | Media | Carrier | | LCh° | Log |
| Example | Media | (hours) | Ratio | pH | pH | ΔE_{c}* | Factor | Reduction |
| Control B | None | N/A | N/A | N/A | 9.68 | N/A | N/A | −0.09 |
| Ex. 13 | None | N/A | N/A | N/A | 8.92 | 8.06 | 3.3% | Not |
| | | | | | | | | measured |
| Ex. 14 | AP | 24 | 1.5 | 8.5 | 8.86 | 6.29 | 1.6% | Not |
| | | | | | | | | measured |
| Ex. 15 | AP | 7 | 1.0 | 9.5 | 9.07 | 6.23 | 2.9% | 4.38 |
| Ex. 16 | AP | 24 | 1.0 | 9.5 | 9.09 | 5.91 | 2.0% | Not |
| | | | | | | | | measured |
| Ex. 17 | AP | 7 | 1.5 | 9.5 | 9.05 | 6.58 | 1.4% | 4.38 |
| Ex. 18 | AP | 24 | 1.5 | 9.5 | 9.08 | 6.00 | 2.3% | Not |
| | | | | | | | | measured |
| Ex. 19 | AP | 1 | 1.0 | 10.5 | 9.74 | 7.21 | 1.9% | 4.38 |
| Ex. 20 | AP | 1 | 1.0 | 10.5 | 9.48 | 7.34 | 2.5% | 4.38 |
| | | | | (50% dilute) | | | | |
| Ex. 21 | AC | 1 | 1.0 | 10.5 | 9.75 | 7.14 | 1.3% | 3.10 |
| Ex. 22 | AC | 1 | 1.0 | 10.5 | 9.48 | 7.12 | 1.6% | 4.38 |
| | | | | (50% dilute) | | | | |
| Ex. 23 | AMP-95 | 1 | 1.0 | Conc. (2.5%) | 9.08 | 7.94 | 4.0% | 4.38 |

Table 5 shows the percent change per day for the E_{c}*, L*, C* and h° values for Ex. 1-12, normalized with respect to that value at 0 hours in-can.

TABLE 5

| Example | dE_{c}* | dL* | dC* | dh° |
|---|---|---|---|---|
| Control B | — | — | — | — |
| Ex. 13 | −0.6% | −0.5% | 2.3% | 2.3% |
| Ex. 14 | −0.3% | 1.2% | 0.7% | 0.7% |
| Ex. 15 | 0.0% | −1.5% | 1.7% | 1.7% |
| Ex. 16 | 0.1% | −0.8% | 1.3% | 1.3% |
| Ex. 17 | 0.9% | −0.6% | 0.9% | 0.9% |
| Ex. 18 | −0.1% | −1.0% | 1.5% | 1.5% |
| Ex. 19 | 0.8% | −0.3% | 1.3% | 1.3% |
| Ex. 20 | 0.5% | −0.4% | 1.7% | 1.7% |
| Ex. 21 | 0.8% | −0.2% | 0.9% | 0.9% |
| Ex. 22 | 0.9% | −0.1% | 1.1% | 1.1% |
| Ex. 23 | −0.3% | −0.6% | 2.8% | 2.8% |

As shown in Table 4, pretreatment as described herein resulted in a reduction in color shift of between about 0.7 and about 1.8. Additionally, a reduction in color shift was observed as compared to non-pretreated examples. In some examples, color shift was reduced by as much as about 27% (e.g., ((8.60−5.91)/8.06)*100=27%) with pretreatment as described herein.

### Example III

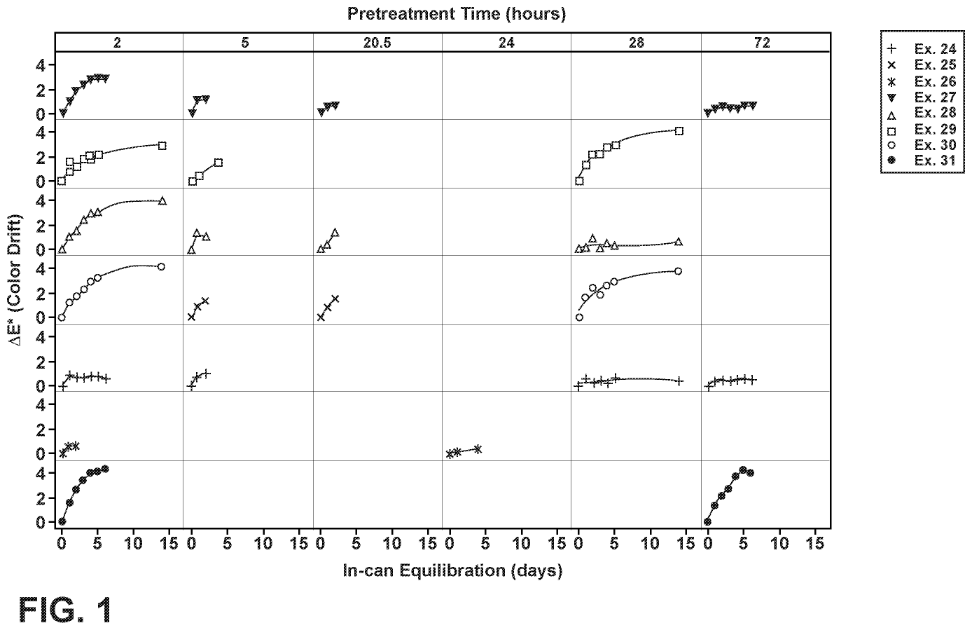

FIG. 1 is a plot illustrating the color drift of paint as the paint ages in the can for paints treated with copper-containing particles that were pretreated with different pretreatment solutions (Ex. 24-31). The copper-containing particles were pretreated with the pretreatment solutions for different periods of time (2, 5, 20.5, 24, 48, and 72 hours) prior to combining with the paint, as indicated on the plot (“Pretreatment Time”).

Ex. 24-31 were prepared by weighing about 1.5 g of copper-containing glass particles into a jar and then adding 2 mL of a pretreatment solution to the jar and continuously stirring for the indicated pretreat time (2, 5, 20.5, 24, 48, and 72 hours). An amount of a commercial latex paint was added to the jar at the end of the pretreat time to result in a dose of 75 g of copper-containing particles per gallon of paint (75 g/gal) and the mixture was mixed for 10 minutes using an overhead mixer. The color of each treated paint Ex. 24-31 was measured on day 0 and after storage for the indicated number of days (referred to as “in-can equilibration”). The color was measured by forming a 7 mil wet film using a bird application and measuring the L*a*b* values using an XRITE 450S colorimeter after 1 day of drying. The color change is reported as ΔE₀*, determined according to formula (II) above. Table 6 below lists the pretreatment solution used to treat the copper-containing glass particles for each of Ex. 24-31. The BPS buffer was made using boric acid, potassium chloride, and sodium hydroxide in relative proportions to provide the buffer with the indicated pH (pH 9 and 10). AMP-95™ is a 90 wt % 2-amino-methyl-1-propanol solution containing 5 wt % added water (available from Sigma-Aldrich).

TABLE 6

| Example | Pretreatment Solution Material | Pretreatment Solution pH |
|---|---|---|
| Ex. 24 | Ammonium phosphate buffer | 8.5 |
| Ex. 25 | BPS buffer | 9 |
| Ex. 26 | Ammonium phosphate buffer | 9.5 |
| Ex. 27 | BPS buffer | 10 |
| Ex. 28 | AMP-95 ™ (diluted with water) | 10 |
| Ex. 29 | Ammonium chloride buffer | 10.5 |
| Ex. 30 | AMP-95 ™ (as purchased) | N/A |
| Ex. 31 | Distilled water | N/A |

As illustrated in FIG. 1, several of the examples in which the copper-containing particles were pretreated with a buffer or amine-containing material, such as Ex. 29 and 30, equilibrated faster and to a lower ΔE₀* than Ex. 31 in which the copper-containing particles were only pretreated with distilled water. In some examples, the pretreat time also had an impact on the rate and color to which the paint color equilibrated. For example, Ex. 24 and 26, in which the copper-containing particles were pretreated with an ammonium phosphate buffer, show an increase in the equilibration rate and a lower ΔE₀* at longer pretreat time periods.

### Example IV

A process for preparing an exemplary latex paint including treated copper-containing glass particles is described. The treated copper-containing glass particles can be added at any stage in the paint making process, preferably at a stage that provides good wetting and dispersion. Optionally, the treated copper-containing particles can be added as an extender during the latter part of the pigment dispersion stage, which can facilitate good wetting and dispersion and may safeguard against over-milling. To prepare 1 liter of paint with a dosage of 13.2 g/L of copper-containing glass particles, 13.2 g of treated copper-containing glass particles can be added to the paint at the grind stage, optionally as the last pigment/extender, and dispersed at a suitable mixing rate for a predetermined period of time (e.g., the same mixing rate and time period used for preparing the paint without the copper-containing glass particles).

The treated copper-containing particles can be prepared by mixing 10 g of a 90 wt % 2-amino-methyl-1-propanol solution (e.g., AMP-95™ is a 90 wt % 2-amino-methyl-1-propanol solution containing 5 wt % added water, available from Sigma-Aldrich) with 90 g of deionized water to form 100 mL of a 10 wt % pretreatment solution. 25 g of the pretreatment solution can be combined with 13.2 g of copper-containing glass particles (powder form). The pretreatment solution and copper-containing glass particles can be mixed for 30 minutes (e.g., using sonication or roller mixer) to form treated copper-containing glass particles. The treated copper-containing particles are then combined with the paint as described above.

The concentration of the pretreatment solution and the amounts used to form the treated copper-containing glass particles and amount of material added to the paint can be adjusted and scaled as needed. Optionally, components of the paint, such as neutralizers, are adjusted to account for the addition of the pretreatment solution such that the final pH after combining the paint with the treated copper-containing particles is within ±0.5 units of the initial pH of the paint (e.g., the pH of the paint before addition of the treated copper-containing particles).

The following non-limiting aspects are encompassed by the present disclosure. To the extent not already described, any one of the features of the first through the thirty-seventh aspect may be combined in part or in whole with features of any one or more of the other aspects of the present disclosure to form additional aspects, even if such a combination is not explicitly described.

According to a first aspect of the present disclosure, a biocidal material, comprises: a carrier; and a plurality of treated copper-containing particles comprising a particle surface pre-treatment, and wherein the surface pre-treatment comprises a copper-chelating material.

According to a second aspect of the present disclosure, the biocidal material of aspect 1, wherein the material exhibits a greater than 3 log reduction in a concentration of Staphylococcus aureus, under the U.S. Environmental Protection Agency “Test Method for Efficacy of Copper Alloy as a Sanitizer” (2009) testing conditions.

According to a third aspect of the present disclosure, the biocidal material of aspect 1 or aspect 2, wherein the copper-chelating material is adapted to interact with the copper carried by the copper-containing particles to form a copper complex or a copper precipitate.

According to a fourth aspect of the present disclosure, the biocidal material of any one of aspects 1-3, wherein the copper-containing particles comprise at least one of copper (I) oxide, copper (I) halides, and copper (I) carbonate.

According to a fifth aspect of the present disclosure, the biocidal material of any one of aspects 1-3, wherein the copper-containing particles comprise a copper containing glass.

According to a sixth aspect of the present disclosure, the biocidal material of aspect 5, wherein the copper-containing glass comprises a cuprite phase comprising a plurality of Cu¹⁺ ions, and comprising at least one of B₂O₃, P₂O₅, and R₂O.

According to a seventh aspect of the present disclosure, the biocidal material of aspect 6, wherein the copper-containing glass further comprises a glass phase comprising more than 40 mol % SiO₂.

According to an eighth aspect of the present disclosure, the biocidal material of aspect 7, wherein the glass phase is present in an amount by weight greater than the cuprite phase.

According to a ninth aspect of the present disclosure, the biocidal material of any one of aspects 6-8, wherein the cuprite phase is dispersed in the glass phase.

According to a tenth aspect of the present disclosure, the biocidal material of any one of aspects 6-9, wherein either one or both of the cuprite phase and the glass phase comprise Cu¹⁺ ions.

According to an eleventh aspect of the present disclosure, the biocidal material of any one of aspects 6-10, wherein the cuprite phase comprises crystals having an average major dimension of about 5 micrometers (μm) or less.

According to a twelfth aspect of the present disclosure, the biocidal material of any one of aspects 6-10, wherein the cuprite phase is degradable and leaches in the presence of water.

According to a thirteenth aspect of the present disclosure, the biocidal material of any one of aspects 6-10, wherein the copper-containing glass comprises a surface portion having a depth of less than about 5 nanometers (nm), the surface portion comprising a plurality of copper ions wherein at least 75% of the plurality of copper ions are Cu¹⁺.

According to a fourteenth aspect of the present disclosure, the biocidal material of any one of aspects 1-13, wherein the copper-containing particles are present in an amount of about 150 g/gallon of the carrier or less.

According to a fifteenth aspect of the present disclosure, the biocidal material of any one of aspects 1-14, wherein the carrier comprises at least one of a polymer, monomer, binder, and solvent.

According to a sixteenth aspect of the present disclosure, the biocidal material of any one of aspects 1-15, wherein the carrier comprises paint.

According to a seventeenth aspect of the present disclosure, the biocidal material of any one of aspects 1-16, wherein the copper-chelating material comprises at least one material selected from an ammonia-based solution and amine-based solution having a pH of between about 8 and about 12.

According to an eighteenth aspect of the present disclosure, the biocidal material of any one of aspects 1-17, wherein the copper-chelating material comprises at least one material selected from a hard base and alkaline buffer solution having a pH of at least 9.

According to a nineteenth aspect of the present disclosure, the biocidal material of any one of aspects 1-18, wherein the copper-chelating material comprises at least one material selected from group (I) hydroxides, group (II) hydroxides, sodium hydroxide, potassium hydroxide, ammonia, ammonium phosphate, monoammonium phosphate (NH₄H₂PO₄), phosphate buffers, borate buffers, ammonium buffers, carbonate buffers, and ammonium chloride.

According to a twentieth aspect of the present disclosure, the biocidal material of any one of aspects 1-19, wherein the copper-chelating material comprises at least one material selected from 2-amino-2-methyl-1-propanol, 2-dimethylamino-2-methyl-1-propanol, 2-butylaminoethanol, N-methylethanolamine, 2-amino-2-methyl-1-propanol, monoisopropanolamine, monoethanolamine, N,N-dimethylethanolamine, N-butyldiethanolamine, 2-amino-2-ethyl-1,3-propanediol, 2-amino-2-hydroxymethyl-1,3-propanediol, triethanolamine, 2-(methylamino)ethanol, 1-amino-2-propanol, 2-aminoethanol, 2-dimethylaminoethanol, 2-aminobenzyl alcohol, 2-amino-3-methylbenzyl alcohol, 2-amino-1-phenylethanol, 2-aminocyclohexanol, and triethylamine.

According to a twenty-first aspect of the present disclosure, the biocidal material of any one of aspects 1-20, wherein the biocidal material comprises a CIE ΔE* value of less than about 15, as measured according to formula (I):

ΔE_{c}*={square root over (((L*−L*_{control})²+(a*−a*_{control})²+(b*−b*_{control})²))} (I)

where L*, a*, and b* are the CIE L*, a*, and b* values of the biocidal material and the L*_{control}, a*_{control}, and b*_{control} are the CIE L*, a*, and b* values of the carrier in the absence of the copper-containing particles.

According to a twenty-second aspect of the present disclosure, the biocidal material of any one of aspects 1-21, wherein the treated copper-containing particles are adapted such that a pH of a mixture of the carrier and the treated copper-containing particles is within about ±1 pH units of an initial pH of the carrier prior to combining the carrier and the treated copper-containing particles.

According to a twenty-third aspect of the present disclosure, a method of forming a biocidal material comprises: treating copper-containing particles with a copper-chelating material to form treated copper-containing particles; and combining a carrier and the treated copper-containing particles.

According to a twenty-fourth aspect of the present disclosure, the method of aspect 23, wherein the biocidal material exhibits a greater than 3 log reduction in a concentration of Staphylococcus aureus, under the U.S. Environmental Protection Agency “Test Method for Efficacy of Copper Alloy as a Sanitizer” (2009) testing conditions.

According to a twenty-fifth aspect of the present disclosure, the method of aspects 23 or 24, wherein the treating copper-containing particles with a copper-chelating material comprises treating the copper-containing particles for between about 5 minutes and about 24 hours with the copper-chelating material prior to combining the treated copper-containing particles with the carrier.

According to a twenty-sixth aspect of the present disclosure, the method of any one of aspects 23-25, wherein the carrier comprises an initial pH, and wherein the step of combining a carrier and the treated copper-containing particles comprises combining the carrier and the treated copper-containing particles to produce a mixture having a pH of within ±1 pH units of the carrier initial pH.

According to a twenty-seventh aspect of the present disclosure, the method of any one of aspects 23-26, wherein the copper-chelating material is adapted to interact with the copper carried by the copper-containing particles to form a copper complex or a copper precipitate.

According to a twenty-eighth aspect of the present disclosure, the method of any one of aspects 23-27, wherein the copper-containing particles comprise at least one of copper (I) oxide, copper (I) halides, and copper (I) carbonate.

According to a twenty-ninth aspect of the present disclosure, the method of any one of aspects 23-28, wherein the copper-containing particles comprise a copper-containing glass.

According to a thirtieth aspect of the present disclosure, the method of any one of aspects 23-29, wherein the copper-containing particles are present in an amount of about 150 g/gallon of the carrier or less.

According to a thirty-first aspect of the present disclosure, the method of any one of aspects 23-30, wherein the carrier comprises at least one of a polymer, monomer, binder, and solvent.

According to a thirty-second aspect of the present disclosure, the method of any one of aspects 23-31, wherein the carrier comprises paint.

According to a thirty-third aspect of the present disclosure, the method of any one of aspects 23-32, wherein the copper-chelating material comprises at least one material selected from an ammonia-based solution and amine-based solution having a pH of between about 8 and about 12.

According to a thirty-fourth aspect of the present disclosure, the method of any one of aspects 23-32, wherein the copper-chelating material comprises at least one material selected from a hard base and alkaline buffer solution having a pH of at least 9.

According to a thirty-fifth aspect of the present disclosure, the method of any one of aspects 23-32, wherein the copper-chelating material comprises at least one material selected from group (I) hydroxides, group (II) hydroxides, sodium hydroxide, potassium hydroxide, ammonia, ammonium phosphate, monoammonium phosphate (NH₄H₂PO₄), phosphate buffers, borate buffers, ammonium buffers, carbonate buffers, and ammonium chloride.

According to a thirty-sixth aspect of the present disclosure, the method of any one of aspects 23-32, wherein the copper-chelating material comprises at least one material selected from 2-amino-2-methyl-1-propanol, 2-dimethylamino-2-methyl-1-propanol, 2-butylaminoethanol, N-methylethanolamine, 2-amino-2-methyl-1-propanol, monoisopropanolamine, monoethanolamine, N,N-dimethylethanolamine, N-butyldiethanolamine, 2-amino-2-ethyl-1,3-propanediol, 2-amino-2-hydroxymethyl-1,3-propanediol, triethanolamine, 2-(methylamino)ethanol, 1-amino-2-propanol, 2-aminoethanol, 2-dimethylaminoethanol, 2-aminobenzyl alcohol, 2-amino-3-methylbenzyl alcohol, 2-amino-1-phenylethanol, 2-aminocyclohexanol, and triethylamine.

According to a thirty-seventh aspect of the present disclosure, the method of any one of aspects 23-36, wherein the biocidal material comprises a CIE ΔE* value of less than about 15, as measured according to formula (I):

ΔE_{c}* {square root over (((L*−L*_{control})²+(a*−a*_{control})²+(b*−b*_{control})²))} (I)

where L*, a*, and b* are the CIE L*, a*, and b* values of the biocidal material and the L*_{control}, a*_{control}, and b*_{control} are the CIE L*, a*, and b* values of the carrier in the absence of the copper-containing particles.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

It will be apparent to those skilled in the art that various modifications and variations can be made without departing from the spirit or scope of the invention.

1. A biocidal material, comprising:
a carrier; and
a plurality of treated copper-containing particles comprising a particle surface pre-treatment, and
wherein the surface pre-treatment comprises a copper-chelating material.

2. The biocidal material of claim 1, wherein the material exhibits a greater than 3 log reduction in a concentration of Staphylococcus aureus, under the U.S. Environmental Protection Agency “Test Method for Efficacy of Copper Alloy as a Sanitizer” (2009) testing conditions.

3. The biocidal material of claim 1, wherein the copper-chelating material is adapted to interact with the copper carried by the copper-containing particles to form a copper complex or a copper precipitate.

4. The biocidal material of claim 1, wherein the copper-containing particles comprise at least one of copper (I) oxide, copper (I) halides, and copper (I) carbonate.

5. The biocidal material of claim 1, wherein the copper-containing particles comprise a copper containing glass.

6. The biocidal material of claim 5, wherein the copper-containing glass comprises a cuprite phase comprising a plurality of Cu¹⁺ ions, and comprising at least one of B₂O₃, P₂O₅, and R₂O.

7. The biocidal material of claim 6, wherein the copper-containing glass further comprises a glass phase comprising more than 40 mol % SiO₂ and wherein the glass phase is present in an amount by weight greater than the cuprite phase.

8. (canceled)

9. The biocidal material of claim 6, wherein the cuprite phase is dispersed in the glass phase.

10. The biocidal material of claim 6, wherein either one or both of the cuprite phase and the glass phase comprise Cu¹⁺ ions.

11. The biocidal material of claim 6, wherein the cuprite phase comprises crystals having an average major dimension of about 5 micrometers (μm) or less.

12. The biocidal material of claim 6, wherein the cuprite phase is degradable and leaches in the presence of water.

13. The biocidal material of claim 6, wherein the copper-containing glass comprises a surface portion having a depth of less than about 5 nanometers (nm), the surface portion comprising a plurality of copper ions wherein at least 75% of the plurality of copper ions are Cu¹⁺.

14. The biocidal material of claim 1, wherein the copper-containing particles are present in an amount of about 150 g/gallon of the carrier or less.

15. The biocidal material of claim 1, wherein the carrier comprises at least one of a polymer, monomer, binder, and solvent.

16. The biocidal material of claim 1, wherein the carrier comprises paint.

17. The biocidal material of claim 1, wherein the copper-chelating material comprises at least one material selected from:
(I) an ammonia-based solution and amine-based solution having a pH of between about 8 and about 12, or
(II) a hard base and alkaline buffer solution having a pH of at least 9.

18. (canceled)

19. The biocidal material of claim 1, wherein the copper-chelating material comprises at least one material selected from:
group (I) hydroxides, group (II) hydroxides, sodium hydroxide, potassium hydroxide, ammonia, ammonium phosphate, monoammonium phosphate (NH₄H₂PO₄), phosphate buffers, borate buffers, ammonium buffers, carbonate buffers, and ammonium chloride, 2-amino-2-methyl-1-propanol, 2-dimethylamino-2-methyl-1-propanol, 2-butylaminoethanol, N-methylethanolamine, 2-amino-2-methyl-1-propanol, monoisopropanolamine, monoethanolamine, N,N-dimethylethanolamine, N-butyldiethanolamine, 2-amino-2-ethyl-1,3-propanediol, 2-amino-2-hydroxymethyl-1,3-propanediol, triethanolamine, 2-(methylamino)ethanol, 1-amino-2-propanol, 2-aminoethanol, 2-dimethylaminoethanol, 2-aminobenzyl alcohol, 2-amino-3-methylbenzyl alcohol, 2-amino-1-phenylethanol, 2-aminocyclohexanol, and triethylamine.

20. (canceled)

21. The biocidal material of claim 1, wherein the biocidal material comprises a CIE ΔE* value of less than about 15, as measured according to formula (I):
ΔE_{c}={square root over (((L*−L*_{control})²+(a*−a*_{control})²+(b*−b*_{control})²))} (I)
where L*, a*, and b* are the CIE L*, a*, and b* values of the biocidal material and the L*_{control}, a*_{control}, and b*_{control} are the CIE L*, a*, and b* values of the carrier in the absence of the copper-containing particles.

22. The biocidal material of claim 1, wherein the treated copper-containing particles are adapted such that a pH of a mixture of the carrier and the treated copper-containing particles is within about ±1 pH units of an initial pH of the carrier prior to combining the carrier and the treated copper-containing particles.

23. A method of forming a biocidal material, comprising:
treating copper-containing particles with a copper-chelating material to form treated copper-containing particles; and
combining a carrier and the treated copper-containing particles.

24-37. (canceled)
